(19) United States
(12) Patent Application Publication
(10) Pub. No.: US 2006/0117595 A1
(43) Pub. Date: Jun. 8, 2006

(54) Conduit with improved electric heating element and clothes drying machine provided with such a conduit

(76) Inventors: Andrea Virzi, Treviso (IT); Duilio Caprado, Treviso (IT)

Correspondence Address: WENDEROTH, LIND & PONACK, L.L.P., 2033 K STREET N. W., SUITE 800, WASHINGTON, DC, 20006-1021, US

(21) Appl. No.: 10/534,029

(22) PCT Filed: Sep. 8, 2003
(86) PCT No.: PCT/EP03/09928

§ 371 Date: Jan. 9, 2006

(30) Foreign Application Priority Data
Nov. 7, 2002 (IT) PN2002 A 000086

(51) Int. Cl. F26B 11/02

(52) U.S. Cl. 34/607

(57) ABSTRACT

Conduit for conveying and heating a flow of gas, comprising in its interior at least an electric heating element formed by a thick-film layer, in which said electric heating element works as a positive temperature coefficient (PTC) element and is arranged peripherally in relation to the gas flow cross-section of the conduit, i.e. is oriented in a substantially parallel manner to the flow direction of said gas, so that the latter is not even partially obstructed by such a thick-film layer. In a preferred manner, this heating element is subdivided into a plurality of individual and distinct heating elements arranged in parallel and energized in a successive and cumulative manner so that the initial power input can be maintained within pre-established limits, while the power input under steady-state conditions is reduced to a quite lower value, which is however still sufficiently high as to ensure an acceptable power output level.

The present invention relates to a conduit adapted to convey and heat up a flow of gas, in particular air, provided with an improved kind of electric heating element, and particularly fit for use in drying machines and equipment operating on the basis of a forced circulation of heated air that is forced to flow through an appropriate through-flow heating conduit blowing into a drying chamber. These drying machines or apparatuses may for instance be agricultural, pharmaceutical, food processing, chemical, paper-mill, textile, printing, painting and surface finishing apparatuses; although the present invention may therefore be used in a great variety of different applications entailing generally different circumstances and, at most, only partially common needs and requirements, it is found to be particularly advantageous when it is applied to a household clothes drying machine of the type that will be described further on.

Therefore, although the present invention is to be understood as to refer to a particular kind of conduit, and the improved embodiments thereof, that may be used in a wide range of most different applications, in order to be better emphasize its distinguishing features along with a preferred mode of application, in the following description it will be illustrated, by mere way of example, with reference to the application thereof in a clothes drying machines of the type used in households.

In such clothes drying machines, the drying process is carried out by having a flow of previously heated-up air circulated through a revolving drum that holds the clothes items to be dried, in which the heating of the air so being circulated is totally or partly ensured by a properly arranged and energized electric heating element.

Such clothes drying machines are generally known to include a rotating drum holding the clothes items to be dried, a fan for circulating heated air within said drum, and means for electrically heating up said circulating air; in addition, these types of machines are generally provided with further devices and arrangements for dehumidifying the drying air and/or, as an alternative, for exhausting the moist and hot air flowing from said rotating drum, as well as for taking in fresh air from the surrounding environment. However, all these further devices and arrangements are not relevant to the purposes of the present invention, so that they shall not be dealt with any further.

Anyway, these machines also comprise appropriate means provided for circulating the drying air through the drum, in which such means are substantially constituted by an air-circulating conduit letting into said drum, in which there are arranged at least a fan and a heating element for heating up the air to be blown into the drum.

According to prior-art solutions in general, these air heating conduits are provided with either sheathed-type tubular electric heating elements, possibly inserted in an aluminium die-casting, or hot-wire electric heating elements, in which both types of heating elements are adapted to work at high temperatures, but with a limited dissipation surface.

Both these kinds of conduits have a number of drawbacks that are inherent to their own nature and cannot practically be eliminated, i.e.:

the high temperature reached by the conduits in which there are inserted such sheathed-type or hot-wire heating elements represents a real risk due to the occurrence of such irregular conditions as overheating and possibly even fire, so that it practically makes it necessary for appropriate safety provisions, typically in the form of thermostat switches, to be taken, which however are not such as to be effective in totally eliminating the inherent dangerousness of said heating elements; in addition, their quite elevated operating temperature causes, in the course of the drying cycle, lint and other particles removed from the clothes being dried to even partially burn and char, so that they then reach again the clothes, as conveyed by the same flow of air, as charred corpuscles, thereby contaminating and marring the clothes themselves; finally, the high working temperature of such heating elements causes heat to be transferred by radiation to the walls of the conduit and this of course implies a reduction in the overall energy efficiency and/or the need for appropriate thermal insulation means to be provided;

as far as the conduits provided with hot-wire heating elements are concerned, a possible drawback derives from the possibility for foreign matters flowing in accidentally to short-circuit some parts of the heating element itself, i.e. an occurrence that would entail obvious and well-known problems;

in addition, a problem is being experienced in that the arrangement of the heating element, by obstructing the air-flow cross-section of the conduit, acts as a filter for the same lint and other corpuscle that may be present in the flow of air, and this might in the long run cause the same conduit to become clogged and, as a consequence, a number of other well-known drawbacks to be experienced.

In both kinds of conduits, then, the generation of thermal energy is usually constant under varying temperature conditions of the air, whereas in some definite applications, such as for instance in the case of clothes drying machines, it is highly desirable for the thermal energy being generated to be sensibly reduced as the temperature of the circulating air increases, and this most obviously commands the use of thermostat switches, control devices and the like, under obvious negative consequences as far as both costs and overall reliability are concerned.

As this has already been stated earlier in this description, it should be noticed that such drawbacks are encountered in a household-type clothes drying machine and not necessarily in all of the afore cited or possible uses of the conduit, so that the reader shall closely evaluate the actual existence of what has been just set forth above in applications that are different from the one being described here by way of mere example aimed at the sole purpose of better illustrating the advantages of the present invention in a preferred embodiment thereof.

Based on the above considerations, it is therefore a main object of the present invention to provide a conduit of the type provided with an electric heating element that is arranged laterally in relation to the direction of flow of the air and, as a result, does not bring about any kind of obstruction, not even a potential one, that could constitute a hindrance to the free circulation of the same air flow.

Within this main object, it is a purpose of the present invention to provide a conduit provided with an electric heating element that is capable of being so shaped and formed as to most accurately and compliantly adapt itself to the shape of some side portions of the air conduit, thereby doing away with any need for further obstructions or encumbrances to be added in the air-flow cross-section of the conduit, in which said shaping and forming of the heating element shall be capable of being carried out by means of production processes that are simple, low-cost and easily engineered for industrial manufacturing application.

A further purpose of the present invention is to have the generation of thermal energy distributed in the conduit over a relatively very large surface, so as to reduce the surface temperature thereof and to obtain, as a result, corresponding benefits in terms of safety and efficiency.

Another purpose yet of the present invention is to provide a through-flow heating conduit, in which the heating element is capable of self-regulating as an inverse function of the temperature of the air, and does not require the use of any additional regulation and adjustment means.

A further purpose of the present invention is to provide a conduit in which the possibility is given for the generation of thermal energy to be shared out among a plurality of distinct heating elements, which would enable minimum performance levels to be ensured even in the case of localized failure events, and which would further enable an optimum distribution of the output power to be obtained for a same amount of input power used.

According to the present invention, these aims, along with other features of the invention, are reached in a kind of conduit that is provided with an electric heating element of the thick-film type working as a positive temperature coefficient (PTC) element, which is made and operates as defined in the appended claims.

The present invention may take the form of a preferred, although not sole embodiment, which is described in greater detail and illustrated below by way of non-limiting example with reference to the accompanying drawings, in which:

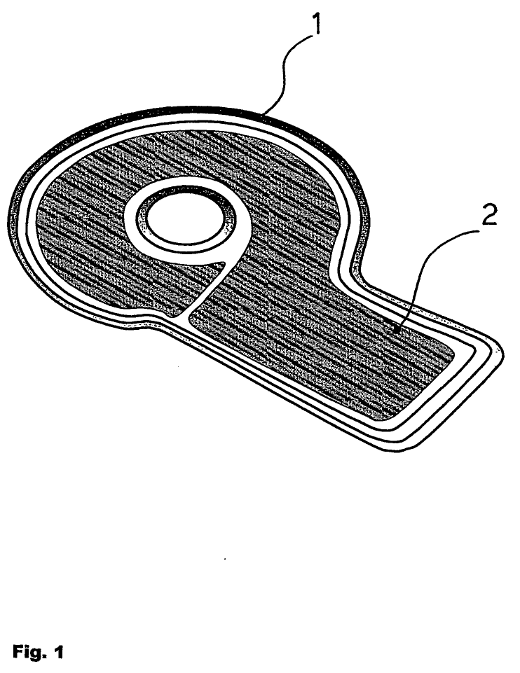

FIG. 1 is an inside view of a portion of a conduit of a clothes drying machine, in which there is applied a heating element according to the present invention;

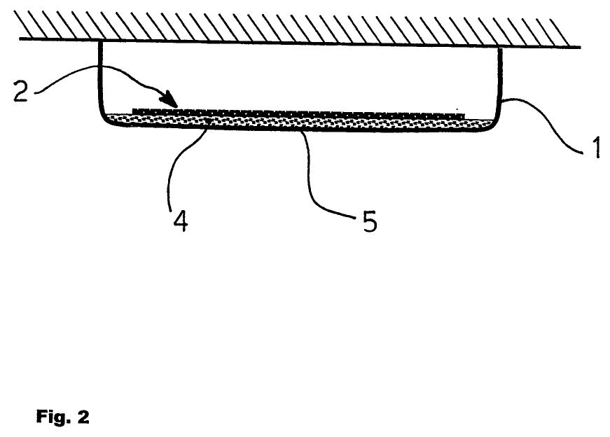

FIG. 2 is a cross-sectional, schematically represented view of a section of the conduit in which said heating element is housed;

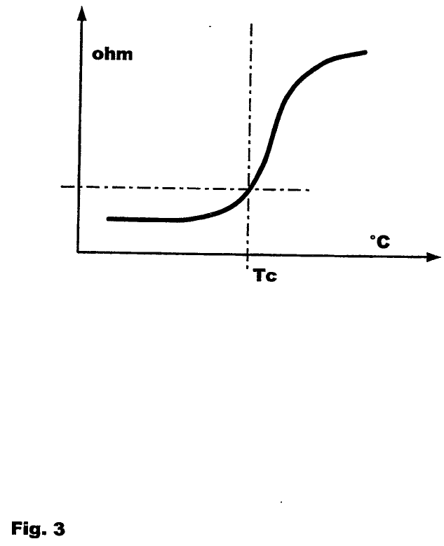

FIG. 3 is a diagrammatical view of an exemplary behaviour of the resistive temperature coefficient of a PTC-type heating element according to the present invention;

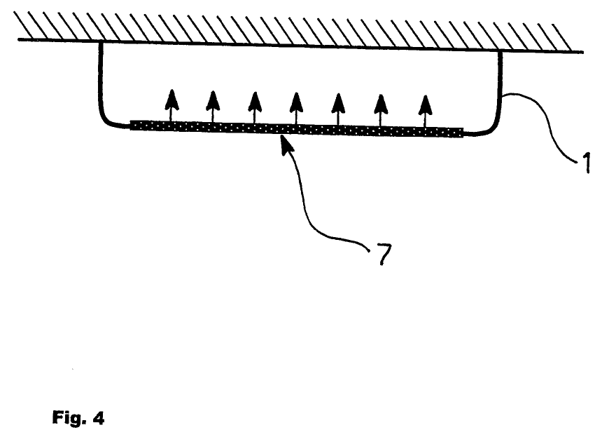

FIG. 4 is a cross-sectional view of an improved embodiment of a conduit according to the present invention;

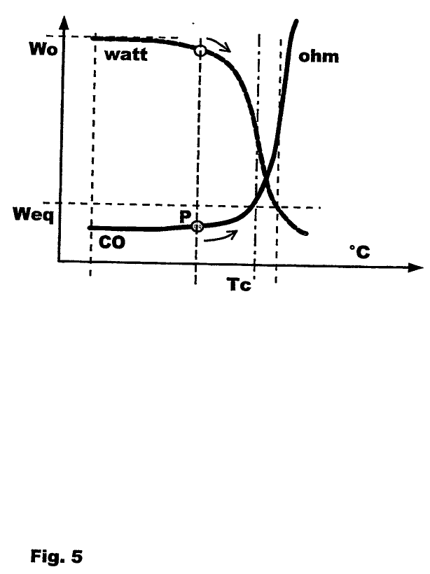

FIG. 5 is a diagrammatical view of an exemplary behaviour of the resistive temperature coefficient of a PTC-type heating element, along with the respective power output in terms of thermal energy;

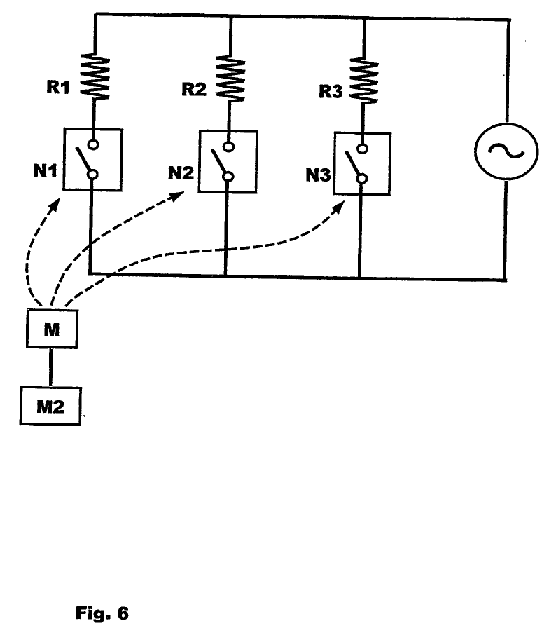

FIG. 6 is a schematical view of the distribution and mutual connection configuration of a plurality of electric heating elements in a conduit according to the present invention;

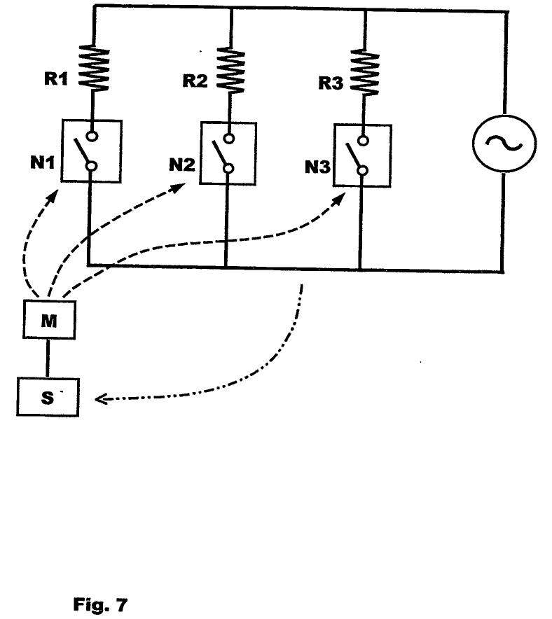

FIG. 7 is a view of a variant in the control, energization and operation scheme of the heating elements shown in FIG. 6:

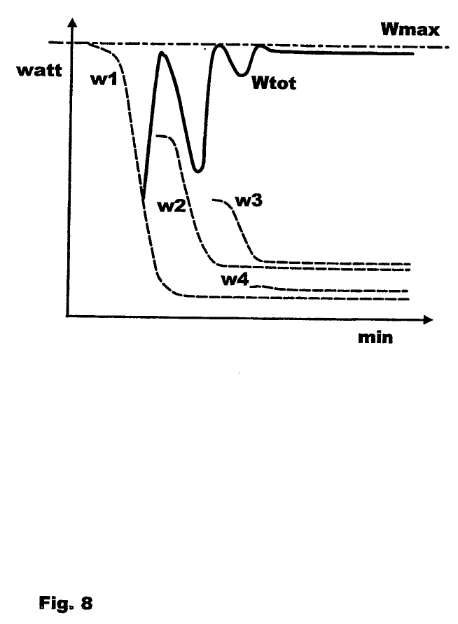

FIG. 8 is a diagrammatical view of the power output pattern of heating elements associated and connected according to the illustration in FIG. 6 or 7.

According to the present invention, a conduit through which there is passing a flow of gas that must be heated up at some point along the path followed by said flow, and which usually makes use of a heating element of a traditional type, can advantageously be improved in its general operation if:

said at least a heating element is arranged in such a manner as to avoid the afore-described drawbacks in the case of an application in a clothes drying machine,

and said heating element is capable of regulating to a certain extent its power output as a function of the temperature of the gas being heated.

The solution that has been found to such an aim consists in making use of a thick-film resistive heating element working as a PIC element, which is made onto a preferably continuous support substrate and is arranged within the conduit in such a manner as to ensure that its outline is compliant with the profile of a portion of the inner wall of the conduit; when it is desired that the flow cross-section of the conduit is maintained substantially unaltered, said thick-film heating element must be arranged as close as possible to said portion of inner wall of the conduit, so as to avoid interfering with the flow of air passing through the same conduit in any way, or at least to minimize any such possible interference. If on the contrary a reduction in the flow cross-section of the conduit is admitted or even desired, e.g. in view of bringing about a state of turbulent, whirling flow aimed at promoting heat exchange, then said thick-film heating element may be arranged even on an intermediate portion of the conduit; however, the flow of air must in this case be guided in such a manner as to flow over, i.e. touch just a single side thereof, and not the opposite side.

With reference to FIGS. 1 and 2, a through-flow heating conduit 1 according to the present invention comprises an electric heating element 2 arranged therewithin. Such a heating element 2 is provided by depositing a layer of thick film onto an insulating substrate (neither of them being specifically shown in the Figures), in which said heating element 2 is made to work with a positive temperature coefficient, hereinafter referred to as PTC (Positive Temperature Coefficient).

The reader should be reminded here that PTC heating elements are used as automatic current regulators, and therefore automatic power output regulators, in all those cases where a high initial current is desired in order to quickly heat up a certain environment or a certain fluid in which said heating element is submerged, while the power output should then be gradually reduced upon reaching pre-established thermal steady-state conditions, to which there generally corresponds a temperature value of the element at which the current starts to drastically reduce; said temperature value is conventionally defined as switching temperature T_{c}.

In such a heating element, furthermore, the temperature coefficient shall be such as to increase in a definitely sensible manner when the pre-established switching temperature is eventually reached, as this is best shown in FIG. 3.

Such a heating element configuration, which looks out practically as a planar plate, allows for the regular state of the flow of air passing through the conduit to remain practically unaltered, or at most to be just slightly modified; in particular, if it is arranged along said portion of inner wall so as to be touched by the airflow passing over it on just a single side thereof, it is necessarily oriented in the same direction of said airflow, so that, among other things, it will neither be able to intercept and retain lint or any other foreign matters nor will it form any additional obstruction in the flow-path along the conduit.

In addition, the large surface with which said heating element can actually be provided, using widely known and readily available techniques and at rather low costs, enables the power output, i.e. heating surface area to be widened and, as a result, the specific power output (per unit of area) and, ultimately, the temperature of the same heating element to be reduced accordingly.

Therefore, this also enables all of the drawbacks deriving from a high temperature to be eliminated, so that a through-flow heating conduit is ultimately obtained, in which the heating element:

has such formability, i.e. is capable of being shaped into such compliant outlines as to practically avoid taking up any additional space inside the conduit,

conforms to the inner walls of said conduit in such a manner as to avoid protruding into the direct flow-path of the air, with obvious advantages,

and, finally, the PTC feature in the working mode of the heating element enables a high power output to be obtained in the initial phases of the process, i.e. when the air is cold and the heat demand is at its maximum, whereas, when the heat demand decreases in the subsequent phases, also the heat generation, i.e. the power output of the heating element decreases in an automatic and corresponding manner owing to such a PTC working feature thereof, due to the effect of a gradually increasing temperature of the air in which said heating element is submerged.

Thick-film heating elements are generally known in the art; they can make use of a polymeric compound, in which very fine particles of metal, graphite, carbon black and other elements are dispersed, and the integration thereof in said polymeric support may be carried out through the addition of an organic solvent so as to form a final fluid mixture that is adapted to be most easily deposited as a rather thin film (although it is generally known as “thick film” in the art).

By appropriately selecting the composition of the thick film, the possibility is given to most easily obtain a heating element that has the desired characteristics of pre-established initial resistance, switching temperature, steepness of the operating curve of FIG. 3 and, therefore, intensity of the PTC effect, as well as highest allowable or sustainable temperature.

Said fluid mixture is usually deposited and formed into a thick film on an appropriate substrate by means of a screen-printing process, followed by a drying step aimed at removing the organic solvent and a firing step aimed at obtaining a kind of continuous final layer.

By appropriately selecting the solvent medium and the conditions of the production process, the possibility is given for a layer of thick film to be applied onto practically any desired material or substrate, including metals, which must however be properly insulated owing to them being conductive, or substantially inert materials such as ceramics, glass-bonded mica or synthetic materials of the most varied type and nature, or even natural materials such as rubber, fibres, textiles, and the like.

The techniques that are generally used to produce thick-film heating elements with PTC working feature are widely known in the art; reference can for instance be made in this connection to the U.S. Pat. No. 5,093,036, which discloses and illustrates a particular family of such heating elements, along with some examples of the related production process.

However, the solution that has just been illustrated above may under certain circumstances pose a problem in that the amount of heat transferred, i.e. wasted by the thick-film heating element towards the outer wall 5 of the conduit 1 is excessive; such a problem may then be advantageously solved by having a properly shaped and sized insulating element 4 interposed between said heating element 2 and said wall 5. Since the temperature of said heating element 2 is normally low, those skilled in the art will have no difficulty in identifying the ideal nature of such a heat-insulating material to be used to that purpose.

Conversely, there may come about particular situations or circumstances, in which the temperature of the thick-film heating element is reduced to a considerable extent, or the outward dissipation of heat is of no actual concern, even on the ground that a very thick and inherently insulating substrate is used or the cross-section area of the conduit is so small that even the installation of a planar thick-film heating element arranged on just a single side of the conduit would give rise to problems, or still other situations whose grounds and causes are however of no actual concern in this particular case.

In all these circumstances, it may prove adequate to simply remove a wall of the conduit 1 and replace the wall so removed with the thick-film heating element itself, which will of course be appropriately shaped and sized, as well as arranged so as to face the interior of the conduit. The heating element is then called to perform a twofold task, i.e. to double as an actual heating element 7 and conduit wall 5, as this is shown schematically in FIG. 4.

However, experimental tests, as supported by a theoretical analysis, have stressed the existence of a particular drawback, which might in this case be encountered in certain applications, such as in a household-type clothes drying machine. In such an application, in fact, the initial phase of the operation occurs at room temperature, so that the need arises for a high power output to be ensured; subsequently, when the temperature of the air increases, the heat demand decreases gradually, owing also to the reduction in the amount of moisture to be removed from the clothes. In front of such a decreasing heat demand, the power output of the heating element is reduced correspondingly, and such a reduction in the power output is usually obtained with means that are known in the art, including safety means that trip if the temperature in the machine rises beyond pre-set limits.

However, the whole set of sensors and related control and actuation means that are to be used to that purpose unavoidably ends up by weighing heavily on production costs and overall reliability.

In an attempt to get over this problem, a suitable thick-film PTC resistive heating element may be selected, which is capable of ensuring a maximum power output initially, i.e. when the machine and the drying air are still cold, while in any case taking into account the constraint that is constituted by the highest heat power output that can be sustained by the installation to which the machine is connected.

Upon starting, the PTC heating element starts of course to heat up, thereby heating up the air flowing through the conduit, and its operation may be identified by the displacement of the point P along the operating curve CO, illustrated in FIG. 5, representing the operation mode of the PTC element.

As a result, the resistive value of the PTC element increases gradually and, therefore, the power output of the same PTC element decreases correspondingly by displacing with the same abscissa along the curve CP until conditions of balance are reached between the power output and the heat taken up by the air flowing through the conduit, in such a manner that the lower the amount of heat being removed from the air, the higher is such a balance value of the temperature of the heating element.

Ultimately, therefore, such a situation is not such as to enable a heat power to be generated, and of course even delivered, which is sufficient in front of the actual drying requirements, so that this configuration is not acceptable.

Such a configuration might be used in the case that the operating curve of the PTC element would be substantially flat from the start up to the bend to start then increasing in a much steeper manner. However, there are no PTC elements available, which have, immediately before the bend, i.e. at a temperature that may be situated anywhere between 80° C. and 180° C., a resistive value that is approximately equal to the initial value; rather, the ratio of the initial power and the power delivered, i.e. the power output under heat-balance conditions is on the contrary of approximately 4 to 5.

In a few words, if a PTC element is to be used for outputting a power that is adequately, although not excessively reduced upon the initial heating-up phase, the currently available PTC elements would output an initial power that is too high as compared with the one that is actually sustained by the installation.

If on the contrary a PTC element is to be used for inputting an initial power that lies within acceptable limits, the power output of the same PIC element would then decrease to such an extent as to make it impossible for the air to even reach a temperature as actually needed to drying purposes.

In view of doing away with such a drawback, the solution shown schematically in FIG. 6 is therefore proposed, which consists in subdividing a single PTC heating element into a plurality of individual, distinct PTC elements R1, R2, R3, etc. connected in parallel and possibly distributed in different zones inside the conduit, in which each one of said elements is then connected in series with a respective controlled switch N1, N2 and N3, these switches being in turn adapted to be selectively driven by appropriate driving and control means M.

Said means M are in turn connected with further general control means M2 of the machine, or anyway of the apparatus that includes said conduit, so as to convey the required signals informing on the state of the operation phases being performed.

Furthermore, said means M are adapted to command said controlled switches N1, N2 and N3 to close in a sequential manner, so that the switch N1 is the one that is closed first, followed by the switch N2 and, finally, the switch N3, so that eventually all switches are closed at the same time and, as a result, all related heating elements are energized.

The first heating element R1 is so sized as to ensure that its power input under cold condition is compatible with the power rating of the installation, whereas, after this initial phase, its power input is of course reduced owing the PTC feature of the same heating element. The second heating element R2 is selected so that its initial power input, i.e. its power input at the moment it is energized, but subsequently to the energization of the heating element R1, is compatible with the available power rating of the installation, i.e. the total power rating of the installation minus the power input of the already energized heating element R1. The third heating element R3 is sized and selected according to a similar criterion, so that its initial power input is compatible with the available power rating of the installation, i.e. the total power rating of the installation minus the power input of the already energized heating elements R1 and R2.

The way in which such a solution works is as follows: at a definite initial instant the means M act to sequentially send the related signals to close to said heating elements R1, R2 and R3; given the measures taken as indicated above, the total power input will in all cases and always lie within the maximum allowable limit, although quite close thereto in view of accelerating the process of reaching the pre-set power output for bringing the temperature of the drying air up to the desired value. On the other hand, however, as the temperature of the air increases and tends to approach the ideal value thereof, the value of the temperature T_{c} for each heating element is eventually exceeded, so that the final power output of each such heating element and, therefore, the aggregate of said heating elements is reduced to a very significant extent, exactly as desired.

In practice, the heating power is shared out among several distinct heating elements and switched on at successive moments, so as to achieve the desired result of having the maximum power delivered at each instant in the initial and intermediate phases of operation, along with the result of having the following heating elements, i.e. the elements to be switched on subsequently, advantageously pre-heated, whereas in the final phase and under heat balance condition the PTC feature steps in automatically to automatically reduce the power output.

With reference to FIG. 8, a complete diagram is shown there, which illustrates the pattern of the heating power outputs W1, W2, W3 on a same time scale; in particular, the curves in this diagram illustrate the power output pattern of the heating elements R1, R2 and R3 that are switched on in an orderly sequence at the three respective instants. It can be clearly seen that the course of each power output becomes markedly decreasing after a pre-establishable time from the respective heating element having been switched on, and exactly at that moment the next heating element is suitably switched on, so that the output of heating power goes on unaltered until a pre-set temperature is eventually reached.

The heating power that can be output in the aggregate, and versus time, with such a solution is represented in the same FIG. 8, in which the ordinates of the three curves are summed up, thereby obtaining the curve Wtot that symbolically represents the instant power output of the above described arrangement of the three distinct heating elements, which however are considered here in their combined operation, until steady-state, heat-balance conditions are reached in the conduit.

It can therefore be readily appreciated that, given initially the two constraints of a maximum allowable power input P0 and a minimum temperature of the air below which it is not possible to go (in order to ensure an adequate drying effect), and which is a function of both time and the average power output, it is possible—as on the other hand this can most easily be ascertained through routine experimental and assessment work that is fully within the abilities of those skilled in the art—for not only the number of PTC heating elements to be used, but also the required ratings and operating characteristics thereof and, in particular, the proper timing or rate of energization thereof to be identified.

The sequence of the instants at which the heating elements R1, R2, R3 are switched on may be pre-arranged versus time and duly stored in said means M that are activated in correspondence of appropriate operation phases, as indicated by said means M2. As an alternative, energization sequences may be identified for switching on the heating elements in accordance with the temperature being reached at a determined point in the machine or in the conduit, such as for instance the temperature of the air inside the conduit of the clothes drying machine, or anyway the apparatus in which said conduit is included, as detected by suitable temperature sensors S, as this is shown schematically in FIG. 7.

The manner in which said heating elements R1, R2, R3 have to be applied and arranged, the rating and the characteristics of the same elements, as well as the control and connection methods and means are fully within the abilities of those skilled in the art, who can easily identify and experimentally test and verify the optimal solution on the basis of the existing constraints; they shall therefore not be described here any further, even considering that they do not fall within the scope of the present invention.

1. Conduit (1) for conveying and heating a flow of gas, comprising in its interior at least an electric heating element, characterized in that said at least a heating element:
is formed by a thick-film layer (2),
works as a positive temperature coefficient (PTC) element,
is arranged within said conduit (1), and
delimits said flow of gas at least on one side.

2. Conduit according to claim 1, characterized in that said thick-film heating element (2) is substantially arranged close to and along at least a portion of inner wall (5) of said conduit.

3. Conduit according to claim 1, characterized in that between said thick-film PTC heating element (2) and the corresponding inner-wall portion (5) there is interposed a layer of insulating material (4).

4. Conduit according to the preamble of claim 1, characterized in that said heating element:
is formed by a thick-film layer (2),
works as a positive temperature coefficient (PTC) element,
forms an integral part (7) of a portion of wall of said conduit, in such a manner that it is substantially oriented in a parallel manner to the flow direction of said gas, so that the latter is not even partially obstructed by such a thick-film layer.

5. Conduit according to claim 1, characterized in that:
said thick-film PTC heating element is subdivided into a plurality of individual and distinct heating elements (R1, R2, R3) featuring at least partly a PTC working mode,
each one of said distinct heating elements is energized independently (parallel-connected heating elements),
each one of said distinct heating elements is connected individually in series with a respective switch means (N1, N2, N3),
the operation of said switch means is driven by command signals issued by a driving and control unit (M),
said driving and control unit processes and outputs said command signals as a pre-established function of signals received from a control means (M2) provided to control the general operation of the apparatus in which said conduit is included.

6. Conduit according to claim 1, characterized in that:
said thick-film PTC heating element is subdivided into a plurality of individual and distinct heating elements (R1, R2, R3),
each one of said distinct heating elements is energized independently (parallel-connected heating elements),
each one of said distinct heating elements is connected individually in series with a respective switch means (N1, N2, N3),
the operation of said switch means is driven by command signals issued by a driving and control unit (M),
said driving and control unit processes and outputs said command signals as a function of an external temperature detected by a respective appropriate sensor (S).

7. Conduit according to claim 6, characterized in that said temperature sensor (S) is adapted to measure the temperature of the gas flowing through said conduit (1), or the temperature of the surfaces of said conduit, at a pre-established position.

8. Clothes drying machine comprising a conduit (1) for circulating a flow of forced and heated-up air and for blowing said flow of air into the drum holding the clothes to be dried, characterized in that said conduit is provided and made according to claim 1.

9. Conduit according to claim 2, characterized in that between said thick-film PTC heating element (2) and the corresponding inner-wall portion (5) there is interposed a layer of insulating material (4).

10. Conduit according to claim 2, characterized in that:
said thick-film PTC heating element is subdivided into a plurality of individual and distinct heating elements (R1, R2, R3) featuring at least partly a PTC working mode,
each one of said distinct heating elements is energized independently (parallel-connected heating elements),
each one of said distinct heating elements is connected individually in series with a respective switch means (N1, N2, N3),
the operation of said switch means is driven by command signals issued by a driving and control unit (M),
said driving and control unit processes and outputs said command signals as a pre-established function of signals received from a control means (M2) provided to control the general operation of the apparatus in which said conduit is included.

11. Conduit according to claim 3, characterized in that:
said thick-film PTC heating element is subdivided into a plurality of individual and distinct heating elements (R1, R2, R3) featuring at least partly a PTC working mode,
each one of said distinct heating elements is energized independently (parallel-connected heating elements),
each one of said distinct heating elements is connected individually in series with a respective switch means (N1, N2, N3),
the operation of said switch means is driven by command signals issued by a driving and control unit (M),
said driving and control unit processes and outputs said command signals as a pre-established function of signals received from a control means (M2) provided to control the general operation of the apparatus in which said conduit is included.

12. Conduit according to claim 4, characterized in that:
said thick-film PTC heating element is subdivided into a plurality of individual and distinct heating elements (R1, R2, R3) featuring at least partly a PTC working mode,
each one of said distinct heating elements is energized independently (parallel-connected heating elements),
each one of said distinct heating elements is connected individually in series with a respective switch means (N1, N2, N3),
the operation of said switch means is driven by command signals issued by a driving and control unit (M),
said driving and control unit processes and outputs said command signals as a pre-established function of signals received from a control means (M2) provided to control the general operation of the apparatus in which said conduit is included.

13. Conduit according to claim 2, characterized in that:
said thick-film PTC heating element is subdivided into a plurality of individual and distinct heating elements (R1, R2, R3),
each one of said distinct heating elements is energized independently (parallel-connected heating elements),
each one of said distinct heating elements is connected individually in series with a respective switch means (N1, N2, N3),
the operation of said switch means is driven by command signals issued by a driving and control unit (M),
said driving and control unit processes and outputs said command signals as a function of an external temperature detected by a respective appropriate sensor (S).

14. Conduit according to claim 3, characterized in that:
said thick-film PTC heating element is subdivided into a plurality of individual and distinct heating elements (R1, R2, R3),
each one of said distinct heating elements is energized independently (parallel-connected heating elements),
each one of said distinct heating elements is connected individually in series with a respective switch means (N1, N2, N3),
the operation of said switch means is driven by command signals issued by a driving and control unit (M),
said driving and control unit processes and outputs said command signals as a function of an external temperature detected by a respective appropriate sensor (S).

15. Conduit according to claim 4, characterized in that:
said thick-film PTC heating element is subdivided into a plurality of individual and distinct heating elements (R1, R2, R3),
each one of said distinct heating elements is energized independently (parallel-connected heating elements),
each one of said distinct heating elements is connected individually in series with a respective switch means (N1, N2, N3),
the operation of said switch means is driven by command signals issued by a driving and control unit (M),
said driving and control unit processes and outputs said command signals as a function of an external temperature detected by a respective appropriate sensor (S).

16. Conduit according to claim 13, characterized in that said temperature sensor (S) is adapted to measure the temperature of the gas flowing through said conduit (1), or the temperature of the surfaces of said conduit, at a pre-established position.

17. Conduit according to claim 14, characterized in that said temperature sensor (S) is adapted to measure the temperature of the gas flowing through said conduit (1), or the temperature of the surfaces of said conduit, at a pre-established position.

18. Conduit according to claim 15, characterized in that said temperature sensor (S) is adapted to measure the temperature of the gas flowing through said conduit (1), or the temperature of the surfaces of said conduit, at a pre-established position.

19. Clothes drying machine comprising a conduit (1) for circulating a flow of forced and heated-up air and for blowing said flow of air into the drum holding the clothes to be dried, characterized in that said conduit is provided and made according to claim 2.

20. Clothes drying machine comprising a conduit (1) for circulating a flow of forced and heated-up air and for blowing said flow of air into the drum holding the clothes to be dried, characterized in that said conduit is provided and made according to claim 3.
